(19) United States
(12) Patent Application Publication
(10) Pub. No.: US 2021/0358654 A1
(43) Pub. Date: Nov. 18, 2021

(54) SUBSTRATE

(71) Applicant: JAPAN AVIATION ELECTRONICS INDUSTRY, LIMITED, Tokyo (JP)

(72) Inventors: Kenta TSUCHIYA, Tokyo (JP); Daisuke HIRAOKA, Tokyo (JP); Osamu HIRATA, Tokyo (JP)

(73) Assignee: JAPAN AVIATION ELECTRONICS INDUSTRY, LIMITED, Tokyo (JP)

(21) Appl. No.: 16/630,178

(22) PCT Filed: Jun. 4, 2018
(86) PCT No.: PCT/JP2018/022130

§ 371 Date: Jan. 10, 2020

(30) Foreign Application Priority Data
Aug. 25, 2017 (JP) 2017-161942

(51) Int. Cl. H01B 5/14; G02B 27/00

(52) U.S. Cl. CPC H01B 5/14; B60J 3/007; G02B 27/0025

(57) ABSTRACT

A substrate is transparent and has a mesh shape conductor pattern. In a first substrate, a conductor pattern includes arrays of circular closed curves, and respective adjacent arrays include arrays different in period, waveform, or phase. In a second substrate, the mesh shape is formed by two or more types of circular closed curves. In a third substrate, the mesh shape is formed by three or more types of circular closed curves. In a fourth substrate, a single type of circular closed curves is used, and one circular closed curve is surrounded by six circular closed curves. In a fifth substrate, a single type of circular closed curves is used. However, four circles contact with one circle at top, bottom, left, and right, is excluded. In a sixth substrate, one or more types of circular closed curves are used, and three or more types of openings are formed.

### TECHNICAL FIELD

The present invention relates to a transparent substrate in which a conductor pattern having a mesh shape is formed.

### BACKGROUND ART

The film antenna disclosed in Patent Literature 1 is known as a transparent substrate of related art in which a conductor pattern having a mesh shape is formed. In Patent Literature 1, an antenna circuit composed of a net-like conductor is formed so that the antenna circuit is not visually outstanding. FIG. 1 illustrates the conductor pattern disclosed in Patent Literature 1. Patent Literatures 2 to 4 disclose the techniques related to a conductive film in which a conductor pattern having a mesh shape is formed and a transparent heating element. Each of Patent Literatures 2 to 4 points out that shafts of light are generated due to backlight or the like and discloses the technique for preventing shafts of light.

### PRIOR ART LITERATURE

### Patent Literature

Patent Literature 1: Japanese Patent Application Laid Open No. H1-49302

Patent Literature 2: Japanese Patent Application Laid Open No. 2009-302035

Patent Literature 3: Japanese Patent Application Laid Open No. 2015-131633

Patent Literature 4: Japanese Patent Application Laid Open No. 2016-190617

### SUMMARY OF THE INVENTION

### Problems to be Solved by the Invention

A “shaft of light” generally means “a tip of light; light seemed as a line” (refer to “Kojien”, the sixth edition). In the technical field related to the present application, it means a line of light generated when light passes through a transparent substrate in which a conductor pattern having a mesh shape is formed. FIG. 2 illustrates an example of shafts of light. The drawing illustrates shafts of light generated due to backlight of cars, light of signals, and the like. Each of Patent Literatures 2 to 4 discloses an example of a technique for preventing shafts of light, but does not disclose a technique for comprehensively preventing shafts of light.

Therefore, the present invention aims to add examples of the technique for preventing shafts of light.

### Means to Solve the Problems

Each substrate according to the present invention is a transparent substrate in which a conductor pattern having a mesh shape is formed. In a first substrate according to the present invention, the conductor pattern includes a part composed of a plurality of arrays of circular closed curves. Respective adjacent arrays include arrays different in any of period, waveform, or phase. The substrate includes an opening surrounded by two or more circular closed curves. In a second substrate according to the present invention, the mesh shape is formed by arranging two or more types of circular closed curves having different sizes. In a third substrate according to the present invention, the mesh shape is formed by arranging three or more types of circular closed curves having different sizes. In a fourth substrate according to the present invention, the conductor pattern includes a part having periodicity. In the part, which has periodicity, of the conductor pattern, a single type of circular closed curves is used for forming the mesh shape, and one circular closed curve is surrounded by six other circular closed curves. In a fifth substrate according to the present invention, the conductor pattern includes a part having periodicity. In the part, which has periodicity, of the conductor pattern, a single type of circular closed curves is used for forming the mesh shape. However, an arrangement in which one circle is in contact with other circles at four positions, top, bottom, left, and right, is excluded. In a sixth substrate according to the present invention, the conductor pattern includes a part having periodicity. In the part, which has periodicity, of the conductor pattern, one or more types of circular closed curves are used for forming the mesh shape, and the substrate includes openings of three or more types of shapes are formed.

### Effects of the Invention

According to the substrate of the present invention, the technique for preventing shafts of light in a different way from the techniques disclosed in Patent Literatures 2 to 4 is described, providing an equivalent or superior advantageous effect for preventing shafts of light.

### BRIEF DESCRIPTION OF THE DRAWINGS

FIG. 1 is a diagram illustrating a conductor pattern described in Patent Literature 1.

FIG. 2 is a diagram illustrating an example of shafts of light.

FIG. 3 is a diagram illustrating an example of a mesh bringing shafts of light observed.

FIG. 4 is a diagram illustrating an example of a mesh by which shafts of light are prevented.

FIG. 5 is a diagram illustrating a result obtained by simulating distribution of light intensity for each mesh shape.

FIG. 6 is a diagram illustrating a configuration example of a substrate according to the present invention.

FIG. 7 is a diagram illustrating a conductor pattern 900 in which respective adjacent arrays are the same as each other in all of period, waveform, and phase.

FIG. 8 is a diagram illustrating a conductor pattern 100 in which respective adjacent arrays are the same as each other in period and waveform but are different from each other in phase.

FIG. 9 is a diagram illustrating a conductor pattern 150 in which respective adjacent arrays are the same as each other in period and waveform but are different from each other in phase.

FIG. 10 is a diagram illustrating a conductor pattern 200 in which respective adjacent arrays are the same as each other in period but are different from each other in waveform.

FIG. 11 is a diagram illustrating a conductor pattern 250 in which respective adjacent arrays are different from each other in period.

FIG. 12 is a diagram illustrating a conductor pattern 160 in which circular closed curves are overlapped with each other.

FIG. 13 is a diagram illustrating a conductor pattern 170 in which gaps are formed among circular closed curves and connecting lines for connecting the circular closed curves are formed in the gaps.

FIG. 14 is a diagram illustrating a conductor pattern 300 in which three types of circular closed curves are arranged.

FIG. 15 is a diagram illustrating a conductor pattern 350 in which three types of circular closed curves are arranged.

FIG. 16 is a diagram illustrating a conductor pattern 400 in which two types of circular closed curves are arranged.

FIG. 17 is a diagram illustrating a conductor pattern 500 in which two types of circular closed curves are arranged.

FIG. 18 is a diagram illustrating a conductor pattern 550 in which two types of circular closed curves are arranged.

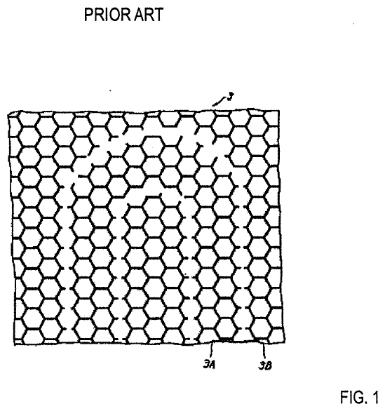

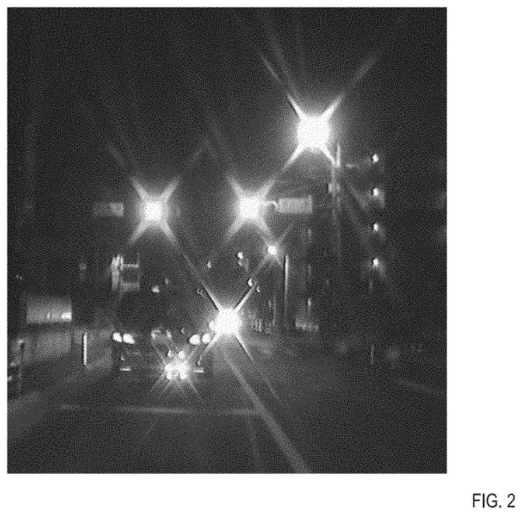

### DETAILED DESCRIPTION OF THE EMBODIMENTS

An embodiment of the present invention is detailed below. Components having the same functions are given the same reference characters and duplicate description thereof is omitted.

### First Embodiment

The present invention relates to a transparent substrate in which a conductor pattern having a mesh shape is formed. The “transparent substrate” is a transparent insulator and may be a board made of glass, resin, or the like, or a film to be pasted on a window. A conductor pattern is formed on a surface of a transparent substrate or in the transparent substrate so that the conductor pattern is not easily visually recognized. Patent Literatures 1 to 4 describe applications of a conductor pattern: an antenna and a heating material. However, applications are not limited in the present application. Spacing in a mesh may be set from 100 micrometers to several millimeters, and a line width of a conductor pattern may be set from several micrometers to several dozens of micrometers. However, it is conceivable that requirement for visibility varies depending on applications, so that spacing in a mesh and a line width of a conductor pattern may be appropriately set depending on required visibility.

<Analysis>

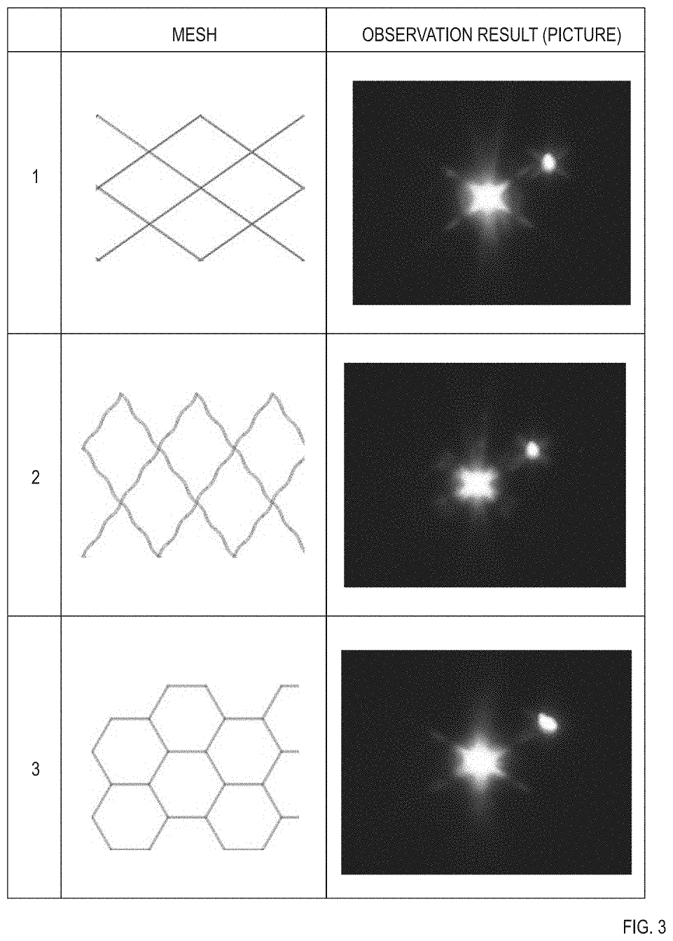

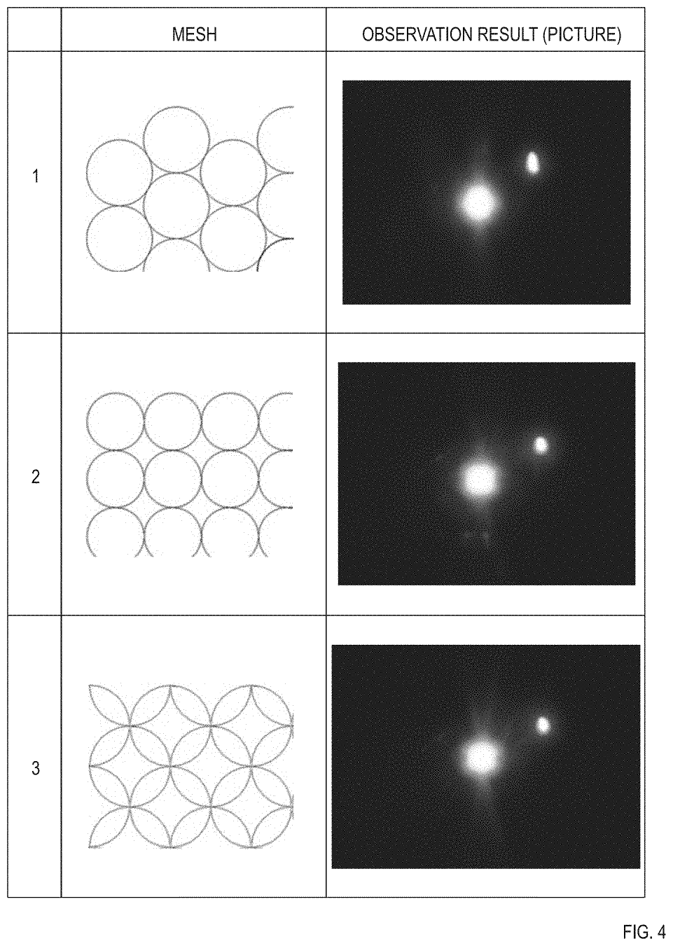

FIG. 3 illustrates an example of a mesh bringing shafts of light observed. FIG. 4 illustrates an example of a mesh by which shafts of light are prevented. In FIG. 3 and FIG. 4, green LED light is shown on the central part of observation results and red LED light is shown on the upper right side. Since difference in shafts of light is easily recognized in green light in this observation, the description is provided while referring to light on the central part. A first mesh in FIG. 3 is composed of rhombuses, a second mesh in FIG. 3 is composed of shapes obtained by changing each side of rhombuses to a waved line, and a third mesh in FIG. 3 is composed of hexagons. Shafts of light are clearly observed in the observation results shown in FIG. 3. However, the second observation result shows smaller shafts of light than those in the first observation result. It is conceivable that this is caused by the change of each side to a waved line. That is, shafts of light are more easily generated when each side is a straight line. Thus, shafts of light are generated depending on a shape of closed curves composing a mesh. Here, a “closed curve” means a shape closed by straight lines or curved lines. Examples of a closed curve include a rhombus, a shape obtained by changing each side of a rhombus to a waved line, a hexagon, and a circle.

Meshes illustrated in FIG. 4 are formed by arranging circular closed curves. A “circular closed curve” means not only an exact circle but also an oval and a shape obtained by changing a part of a circle to a straight line, for example. Though shafts of light in the observation results are blurred in all directions in FIG. 4, clear shafts of light as those in the examples in FIG. 3 cannot be observed.

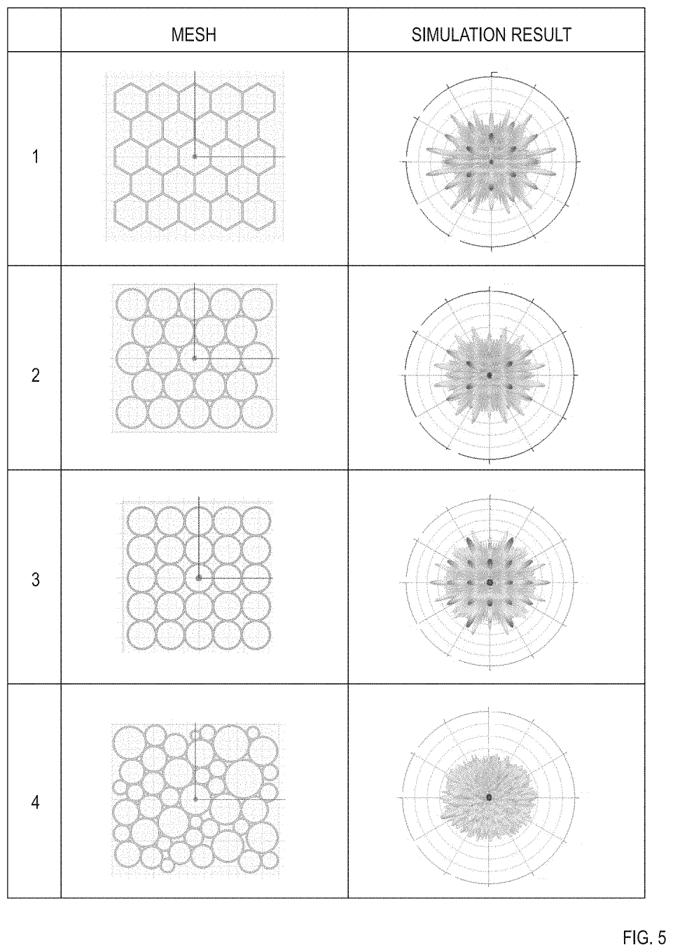

FIG. 5 illustrates a result obtained by simulating distribution of light intensity for each mesh shape. A black part in the simulation results is a part exhibiting higher light intensity. Shafts of light are easily observed when light intensity is high only in a particular direction. The first drawing of FIG. 5 illustrates a simulation result for a mesh composed of hexagons. The result is the same as the third observation result in FIG. 3 in which shafts of light have been observed in six directions.

The second mesh of FIG. 5 and the first mesh of FIG. 4 are the same mesh and the third mesh of FIG. 5 and the second mesh of FIG. 4 are the same mesh. The second simulation result in FIG. 5 shows few black parts. Accordingly, it is considered that shafts of light have not been observed in the first observation result in FIG. 4. The third simulation result in FIG. 5 shows several black parts. However, the black parts are spread in multiple directions, so that it is considered that these parts have not been observed as shafts of light in the second observation result in FIG. 4. When the second result and the third result in FIG. 5 are compared to each other, it is considered that the second mesh is more suitable for prevention of shafts of light because light having high intensity is not spread in the second result.

The fourth mesh in FIG. 5 is formed by irregularly arranging five types of circles having different sizes. In the simulation result of this example, there are no black parts other than the center. Further, light in low intensity is substantially equally spread in all directions. That is, this is more suitable for prevention of shafts of light compared to the second mesh of FIG. 5. Accordingly, it is considered that shafts of light can be more easily prevented if a mesh is composed of circular closed curves having different sizes.

In other words, it is understood that shafts of light are easily generated when conditions:
a shape of openings is composed of only straight lines (polygonal), and
identical shapes are orderly arranged (all of periods, waveforms, and phases are respectively the same between arrays) are satisfied. Here, an “opening” means a part which is defined by a line/lines of a conductor pattern and in which a conductor is not present. “Period”, “waveform”, and “phase” are described later.

Patent Literatures 2 to 4 disclose the technique for preventing shafts of light by different means from that of the present application. FIG. 5 of Patent Literature 2 illustrates the second mesh of FIG. 4 (the third mesh of FIG. 5). However, Patent Literatures 2 to 4 do not show or imply the first mesh of FIG. 4 (the second mesh of FIG. 5), the third mesh of FIG. 4, or the fourth mesh of FIG. 5.

Specific shapes 1 to 6 below describe definition of shapes (mesh shapes) of conductor patterns for preventing shafts of light and explain terms.

<Specific Shape 1>

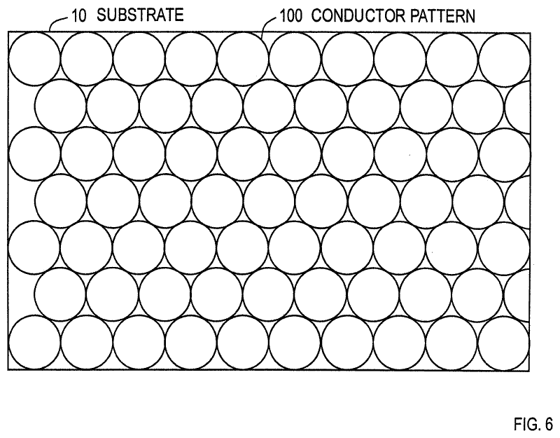

FIG. 6 illustrates a configuration example of a substrate according to the present invention. A substrate 10 is a transparent substrate in which a conductor pattern 100 having a mesh shape is formed. The “transparent substrate” is a transparent insulator and may be a board made of glass, resin, or the like, or a film to be pasted on a window. The conductor pattern 100 includes a part composed of a plurality of arrays of circular closed curves. Respective adjacent arrays include arrays different in any of period, waveform, or phase. Further, the substrate 10 includes openings surrounded by two or more circular closed curves.

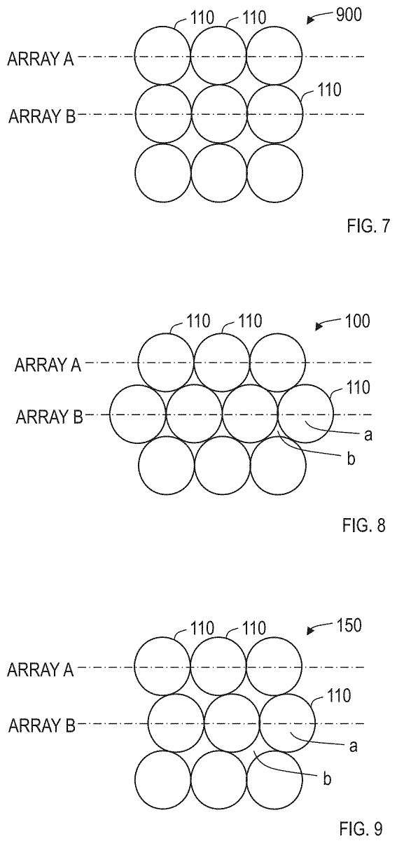

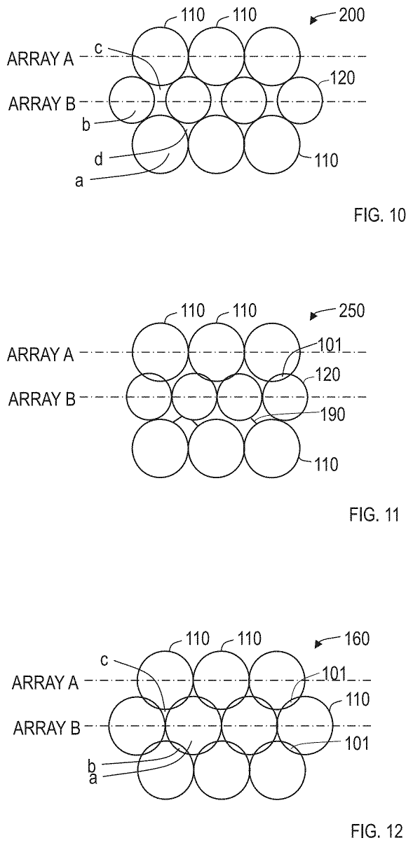

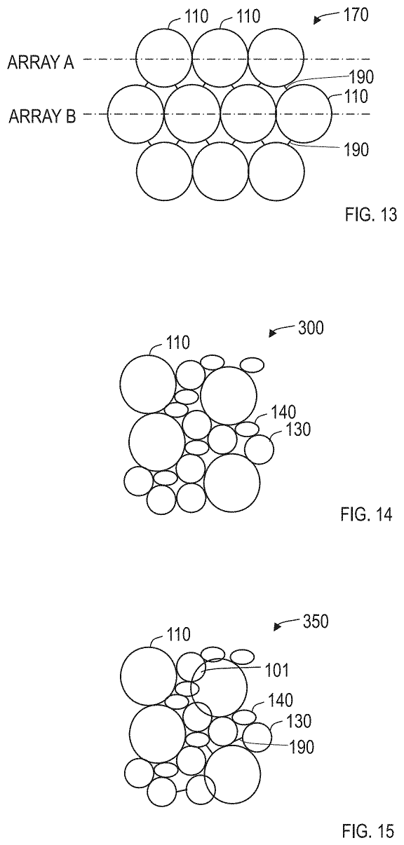

FIG. 7 illustrates a conductor pattern 900 in which respective adjacent arrays are the same as each other in all of period, waveform, and phase. FIG. 8 illustrates the conductor pattern 100 in which respective adjacent arrays are the same as each other in period and waveform but are different from each other in phase. FIG. 9 illustrates a conductor pattern 150 in which respective adjacent arrays are the same as each other in period and waveform but are different from each other in phase. FIG. 10 illustrates a conductor pattern 200 in which respective adjacent arrays are the same as each other in period but are different from each other in waveform. FIG. 11 illustrates a conductor pattern 250 in which respective adjacent arrays are different from each other in period. FIG. 12 illustrates a conductor pattern 160 in which circular closed curves are overlapped with each other. FIG. 13 illustrates a conductor pattern 170 in which gaps are formed among circular closed curves and connecting lines for connecting the circular closed curves are formed in the gaps.

A “circular closed curve” means not only an exact circle but also an oval and a shape obtained by changing a part of a circle to a straight line, for example, and is thus an expression including a range equivalent to a circle in an occurrence of shafts of light. An “array” is a line of circular closed curves constituting a conductor pattern. In FIGS. 7 to 13, arrays in a horizontal direction are described as array A and array B. However, FIG. 7 also has arrays in a vertical direction and FIG. 8 also has oblique arrays. On the other hand, FIG. 11 has arrays in the horizontal direction but does not have arrays in other directions. The description “respective adjacent arrays include arrays different in any of period, waveform, or phase” means that there are adjacent arrays, any of periods, waveforms, or phases of which are different from each other, among adjacent arrays in any direction in which an array can be recognized.

A “period” means a repetition interval in an array and identical “periods” means that the repetition intervals are equal to each other. Circular closed curves 110 of the same size are repeatedly arranged in the array A and the array B in FIGS. 7 to 9 and periods (repetition intervals) are thus the same between arrays each other. Further, circular closed curves 110 are repeatedly arranged in the array A and circular closed curves 120 are repeatedly arranged with intervals therebetween in the array B in FIG. 10. The array A and the array B have the same repetition intervals and the periods of the arrays are therefore the same as each other. Circular closed curves 110 are repeatedly arranged in the array A and circular closed curves 120 are repeatedly arranged in the array B in FIG. 11. The array A and the array B have different repetition intervals from each other and the periods thereof are therefore different from each other.

A “waveform” means positions on which lines of a conductor pattern exist in one period. The circular closed curves 110 of the same size are repeatedly arranged in the array A and the array B in FIGS. 7 to 9 and positions of lines of the conductor patterns are thus the same between arrays in one period. Accordingly, “waveforms” are the same as each other. In FIG. 10, positions of lines of the conductor pattern are different from each other in one period in the array A and the array B and therefore, the array A and the array B are different from each other in “waveform”.

A “phase” means a repetition position. The “phase” is further described by using a different expression. When periods and waveforms of adjacent arrays are respectively the same as each other and one point in one period is set as a position of phase 0, both arrays include the position of the phase 0. A situation that positions of the points defined as the phase 0 are the same as each other between adjacent arrays is a situation that phases are the same as each other, while a situation that positions of the points are different from each other is a situation that phases are different from each other. The circular closed curves 110 are arranged in the same manner between the array A and the array B in FIG. 7, so that “phases” are the same as each other. On the other hand, the circular closed curves 110 of the array A and the circular closed curves 110 of the array B are arranged in a manner to be shifted by a half of a circle in FIG. 8, so that “phases” are different from each other. The circular closed curves 110 of the array A and the circular closed curves 110 of the array B are shifted from each other in FIG. 9 as well, so that “phases” are different from each other. The case where “waveforms” of adjacent arrays are different from each other as illustrated in FIG. 10 corresponds to the situation that “any of periods, waveforms, or phases are different from each other”, so that there is no need for comparing “phases”. Further, the case where “periods” of adjacent arrays are different from each other as illustrated in FIG. 11 corresponds to the situation that “any of periods, waveforms, or phases are different from each other”, so that there is no need for comparing “waveforms” or “phases”.

An “opening” means a part which is defined by a line/lines of a conductor pattern and in which a conductor is not present. In case of the conductor pattern 100 of FIG. 8, there are an opening a surrounded by a circular closed curve 110 and an opening b surrounded by three circular closed curves 110. In case of the conductor pattern 150 of FIG. 9, there are an opening a surrounded by a circular closed curve 110 and an opening b surrounded by four circular closed curves 110. The opening b of FIG. 8 and the opening b of FIG. 9, for example, correspond to an “opening surrounded by two or more circular closed curves (circular closed curves constituting an array)”.

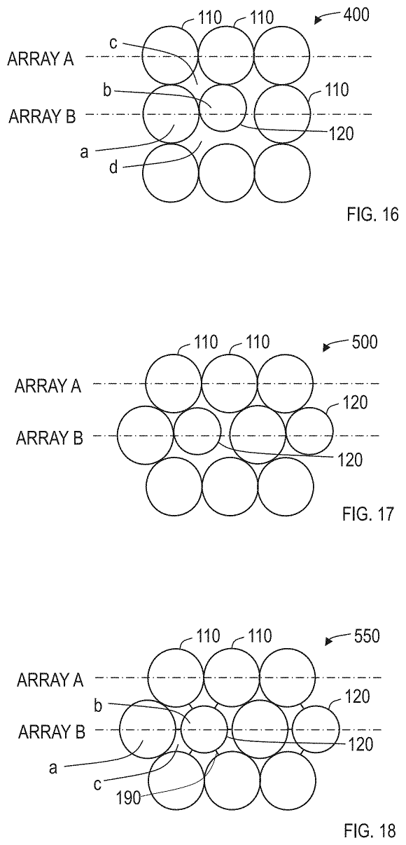

In the specific shape 1, respective adjacent arrays are different from each other in any of periods, waveforms, or phases, so that shafts of light can be equivalently or further prevented compared to the conductor pattern illustrated in FIG. 7. FIG. 8 illustrates the example in which all the circular closed curves 110 are in contact with each other, but the circular closed curves 110 may be overlapped with each other as illustrated in FIG. 12. A reference numeral 101 denotes an overlapped part. As illustrated in FIG. 13, there may be gaps among the circular closed curves 110 and connecting lines 190 for connecting the circular closed curves may be formed in the gaps. Further, as illustrated in FIG. 11, there may be both of the overlapped part 101 and the connecting line 190. Furthermore, conductor patterns 400, 500, and 550 in FIGS. 16 to 18 described later correspond to the specific shape 1 because “waveforms” of adjacent arrays are different from each other.

<Specific Shape 2>

The substrate 10 is a transparent substrate in which a conductor pattern having a mesh shape is formed. The mesh shape is formed by arranging two or more types of circular closed curves having different sizes.

FIG. 14 illustrates a conductor pattern 300 in which three types of circular closed curves are arranged. FIG. 15 illustrates a conductor pattern 350 in which three types of circular closed curves are arranged. FIG. 16 illustrates a conductor pattern 400 in which two types of circular closed curves are arranged. FIG. 17 illustrates a conductor pattern 500 in which two types of circular closed curves are arranged. FIG. 18 illustrates a conductor pattern 550 in which two types of circular closed curves are arranged.

FIG. 14 illustrates an example in which circular closed curves 110, 130, and 140 are in contact with each other. FIG. 15 illustrates an example in which there are overlapped parts 101 and connecting lines 190. The conductor pattern 400 of FIG. 16 has a shape obtained by replacing a part of the circular closed curves 110 illustrated in the conductor pattern 900 of FIG. 7 with a circular closed curve 120 having a smaller size. The conductor pattern 500 of FIG. 17 has a shape obtained by replacing part of the circular closed curves 110 illustrated in the conductor pattern 100 of FIG. 8 with circular closed curves 120 having smaller size. The conductor pattern 550 of FIG. 18 has a shape obtained by replacing part of the circular closed curves 110 illustrated in the conductor pattern 100 of FIG. 8 with circular closed curves 120 having smaller size and by further adding connecting lines 190. The conductor patterns 200 and 250 of FIGS. 10 and 11 also correspond to the specific shape 2.

The specific shape 2 includes two or more types of circular closed curves having different sizes, being more similar to the fourth mesh in FIG. 5 than the shapes of FIGS. 7 to 9. Accordingly, shafts of light can be further prevented compared to the conductor pattern illustrated in FIG. 7. Further, the specific shape 2 is not defined by using an “array”, so that the specific shape 2 can be defined to include a shape as that of the conductor patterns 300 and 350 which are respectively illustrated in FIGS. 14 and 15 and in which any array of circular closed curves cannot be recognized in any directions.

<Specific Shape 3>

The substrate 10 is a transparent substrate in which a conductor pattern having a mesh shape is formed. The mesh shape is formed by arranging three or more types of circular closed curves having different sizes.

The conductor patterns 300 and 350 respectively illustrated in FIGS. 14 and 15 correspond to the specific shape 3. The conductor patterns illustrated in FIGS. 14 and 15 do not have arrays as those of FIGS. 7 to 13 and FIGS. 16 to 18. Thus, the conductor patterns 300 and 350 are further similar to the fourth mesh of FIG. 5. Accordingly, shafts of light can be further prevented.

<Specific Shape 4>

The substrate 10 is a transparent substrate in which a conductor pattern having a mesh shape is formed. Further, the conductor pattern includes a part having periodicity. In the part, which has periodicity, of the conductor pattern, a single type of circular closed curves is used for forming a mesh shape, and one circular closed curve is surrounded by six other circular closed curves.

The conductor patterns 100, 160, and 170 respectively illustrated in FIGS. 8, 12, and 13 correspond to the specific shape 4. These conductor patterns are similar to the second mesh in FIG. 5 and phases of respective adjacent arrays are opposite to each other, so that these conductor patterns can further prevent shafts of light compared to the conductor pattern illustrated in FIG. 7.

<Specific Shape 5>

The substrate 10 is a transparent substrate in which a conductor pattern having a mesh shape is formed. Further, the conductor pattern includes a part having periodicity. In the part, which has periodicity, of the conductor pattern, a single type of circular closed curves is used for forming a mesh shape. Note that an arrangement in which one circle is in contact with other circles at four positions, top, bottom, left, and right, is excluded.

The conductor patterns 100, 150, 160, and 170 respectively illustrated in FIGS. 8, 9, 12, and 13 correspond to the specific shape 5. These conductor patterns have adjacent arrays which are different from each other in phase, being able to equivalently or further prevent shafts of light compared to the conductor pattern illustrated in FIG. 7. The above noting is provided for excluding the shape of FIG. 7.

<Specific Shape 6>

The substrate 10 is a transparent substrate in which a conductor pattern having a mesh shape is formed. Further, the conductor pattern includes a part having periodicity. In the part, which has periodicity, of the conductor pattern, one or more types of circular closed curves are used for forming a mesh shape, and openings of three or more types of shapes are formed.

An “opening” means a part which is defined by a line/lines of a conductor pattern and in which a conductor is not present. The conductor patterns 200, 250, 160, 400, 500, and 550 respectively illustrated in FIGS. 10 to 12 and FIGS. 16 to 18 correspond to the specific shape 6. For example, in case of the conductor pattern 200 in FIG. 10, there are an opening a formed by a circular closed curve 110, an opening b formed by a circular closed curve 120, an opening c surrounded by two circular closed curves 110 and two circular closed curves 120, and an opening d surrounded by two circular closed curves 110 and one circular closed curve 120. In case of the conductor pattern 160 in FIG. 12, there are an opening a formed by five circular closed curves 110 (a shape obtained by removing four overlapped parts 101 from one circular closed curve 110), an opening b formed by two circular closed curves 110 (overlapped part 101), and an opening c formed by three circular closed curves 110. In case of the conductor pattern 400 in FIG. 16, there are an opening a formed by a circular closed curve 110, an opening b formed by a circular closed curve 120, an opening c surrounded by three circular closed curves 110 and one circular closed curve 120, and an opening d surrounded by seven circular closed curves 110 and one circular closed curve 120. In case of the conductor pattern 550 in FIG. 18, there are an opening a formed by a circular closed curve 110, an opening b formed by a circular closed curve 120, and an opening c surrounded by three circular closed curves 110, one circular closed curve 120, and two connecting lines 190.

Waveforms or phases of respective adjacent arrays are differed from each other in these shapes, so that these shapes can further prevent shafts of light compared to the conductor pattern illustrated in FIG. 7.

### DESCRIPTION OF REFERENCE NUMERALS

100, 150, 160, 170, 200, 250, 300, 350, 400, 500, 550, 900 conductor pattern
101 overlapped part
110, 120, 130, 140 circular closed curve
190 connecting line

1. A substrate that is a transparent substrate, in which a conductor pattern having a mesh shape is formed, wherein
the conductor pattern includes a part composed of a plurality of arrays of circular closed curves,
respective adjacent arrays include arrays different in any of period, waveform, or phase, and
the substrate includes an opening surrounded by two or more circular closed curves.

2. A substrate that is a transparent substrate, in which a conductor pattern having a mesh shape is formed, wherein
the mesh shape is formed by arranging two or more types of circular closed curves having different sizes.

3. A substrate that is a transparent substrate, in which a conductor pattern having a mesh shape is formed, wherein
the mesh shape is formed by arranging three or more types of circular closed curves having different sizes.

4. A substrate that is a transparent substrate, in which a conductor pattern is formed, the conductor pattern having a mesh shape and including a part having periodicity, wherein
in the part, the part having periodicity, of the conductor pattern,
a single type of circular closed curves is used for forming the mesh shape, and
one circular closed curve is surrounded by six other circular closed curves.

5. A substrate that is a transparent substrate, in which a conductor pattern is formed, the conductor pattern having a mesh shape and including a part having periodicity, wherein
the part, the part having periodicity, of the conductor pattern is characterized in that a single type of circular closed curves is used for forming the mesh shape, and
an arrangement in which one circle is in contact with other circles at four positions, top, bottom, left, and right, is excluded.

6. A substrate that is a transparent substrate, in which a conductor pattern is formed, the conductor pattern having a mesh shape and including a part having periodicity, wherein
in the part, the part having periodicity, of the conductor pattern,
one or more types of circular closed curves are used for forming the mesh shape, and
the substrate includes openings of three or more types of shapes are formed.

7. The substrate according to claim 1, wherein
the circular closed curves are in contact with each other.

8. The substrate according to claim 1, wherein
the circular closed curves are overlapped with each other.

9. The substrate according to claim 1, wherein
there is a gap among the circular closed curves and a connecting line for connecting the circular closed curves is formed in the gap.

10. The substrate according to claim 2, wherein
the circular closed curves are in contact with each other.

11. The substrate according to claim 2, wherein
the circular closed curves are overlapped with each other.

12. The substrate according to claim 2, wherein
there is a gap among the circular closed curves and a connecting line for connecting the circular closed curves is formed in the gap.

13. The substrate according to claim 3, wherein
the circular closed curves are in contact with each other.

14. The substrate according to claim 3, wherein
the circular closed curves are overlapped with each other.

15. The substrate according to claim 3, wherein
there is a gap among the circular closed curves and a connecting line for connecting the circular closed curves is formed in the gap.

16. The substrate according to claim 4, wherein
the circular closed curves are in contact with each other.

17. The substrate according to claim 4, wherein
the circular closed curves are overlapped with each other.

18. The substrate according to claim 4, wherein
there is a gap among the circular closed curves and a connecting line for connecting the circular closed curves is formed in the gap.

19. The substrate according to claim 5, wherein
the circular closed curves are in contact with each other.

20. The substrate according to claim 5, wherein
the circular closed curves are overlapped with each other.

21. The substrate according to claim 5, wherein
there is a gap among the circular closed curves and a connecting line for connecting the circular closed curves is formed in the gap.

22. The substrate according to claim 6, wherein
the circular closed curves are in contact with each other.

23. The substrate according to claim 6, wherein
the circular closed curves are overlapped with each other.

24. The substrate according to claim 6, wherein
there is a gap among the circular closed curves and a connecting line for connecting the circular closed curves is formed in the gap.
